(19) United States
(12) Patent Application Publication
(10) Pub. No.: US 2013/0198377 A1
(43) Pub. Date: Aug. 1, 2013

(54) CONTROL METHOD, CONTROL SYSTEM, INFORMATION PROCESSING APPARATUS, AND COMPUTER-READABLE NON-TRANSITORY MEDIUM

(71) Applicant: FUJITSU LIMITED, Kawasaki-shi (JP)

(72) Inventors: Yuzuru Asano, Toyama (JP); Hiroshi Miura, Toyama (JP); Takashi Fujii, Yokohama (JP); Atsushi Ishisaka, Namerikawa (JP); Hisato Teguri, Toyama (JP)

(73) Assignee: FUJITSU LIMITED, Kawasaki-shi (JP)

(21) Appl. No.: 13/750,036

(22) Filed: Jan. 25, 2013

(30) Foreign Application Priority Data
Jan. 31, 2012 (JP) 2012-019318

(51) Int. Cl. H04L 12/26

(52) U.S. Cl. CPC H04L 43/04
USPC 709/224

(57) ABSTRACT

A computer-readable, non-transitory medium storing therein an application control program that causes an information processing machine to execute a procedure, the procedure includes, receiving an activation request that requests an activation of a first application of the information processing machine, monitoring another information processing machine that executes a second application corresponding to the first application, and, activating the first application in response to the activation request when a stoppage of an operating system of the another information processing machine is detected.

CROSS-REFERENCE TO RELATED APPLICATION(S)

This application is based upon and claims the benefit of priority of the prior Japanese Patent Application No. JP2012-019318, filed on Jan. 31, 2012, the entire contents of which are incorporated herein by reference.

### FIELD

The embodiment discussed herein is related to a control system having an operating system and spare system.

### BACKGROUND

There are conventional systems that use an information processing machine to control applications. Among the conventional systems, there is a system that includes a spare system (referred to below as a standby system) in addition to a system presently in operation (referred to as an operational system or an active system. Hereinbelow referred to as an operational system). According to this system including the operational system and the standby system, when an abnormality occurs in an active operational system application, the operation may be continued by switching to an application in the standby system and using the standby system application.

Information processing machines in the operational system and the standby system include programs for controlling (referred to below as a control program) the activation and termination of applications. Control programs confirm the operating states of the applications executed in both the operational system and the standby system. For example, when an abnormality occurs in an operational system application, the control program in the operational system stops the application of the operational system in which the abnormality occurred. On the other hand, the control program in the standby system that confirmed the abnormality in the operational system application activates a standby system application that is a spare for the application in which the abnormality occurred. By mutually monitoring the states of the applications, the period of time from stopping one system due to the application abnormality until recovery may be reduced.

When the operational system is stopped due to the abnormality and the operation is switched from the operational system to the standby system, the standby system becomes the new operational system. Moreover, the terminated operational system may be operated as a new standby system after undergoing maintenance to return to a normal operating state. However, when an abnormality occurs in the control program of the current operational system while undergoing maintenance to make the system a new standby system and the control program of the current operational system is stopped, the information processing machines of the operational system and the standby system are not able to mutually monitor the operating states of the applications. Therefore, the operating states of the applications in the current operational system are unreliable.

When an application in the system set as the new standby system is activated in a state in which the operating states of applications in the current operational system are not able to be confirmed, there is a risk that competition between the application of the current operational system and the application of the new standby system may occur. Synchronized operation between the operational system application and the standby system application may lead to major damage to the system such as data corruption due to the operational system application and the standby system application accessing the same data at the same time. Although competition may be avoided by forcibly stopping the entire operational system regardless of the operating state of the operational system, other normal operations that are operating in the operational system are then also stopped due to the forced stoppage. On the other hand, to avoid forcibly stopping, the standby system application may not be activated until the application operating states are confirmed.

As described above, when the operating state of the operational system application is unclear, switching from the operational system to the standby system may not be performed smoothly.

### SUMMARY

According to an aspect of the invention, A computer-readable, non-transitory medium storing therein an application control program that causes an information processing machine to execute a procedure, the procedure includes receiving an activation request that requests an activation of a first application of the information processing machine; monitoring another information processing machine that executes a second application corresponding to the first application; and activating the first application in response to the activation request when a stoppage of an operating system of the another information processing machine is detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a control system;

FIG. 2 illustrates a hardware configuration of a node;

FIG. 3 illustrates a functional configuration of the control system;

FIG. 4 is a flow chart illustrating processing when an application is activated;

FIG. 5 illustrates application information;

FIG. 6 illustrates application information;

FIG. 7 illustrates control program information;

FIG. 8 illustrates OS information;

FIG. 9 illustrates node information.

### DESCRIPTION OF EMBODIMENT

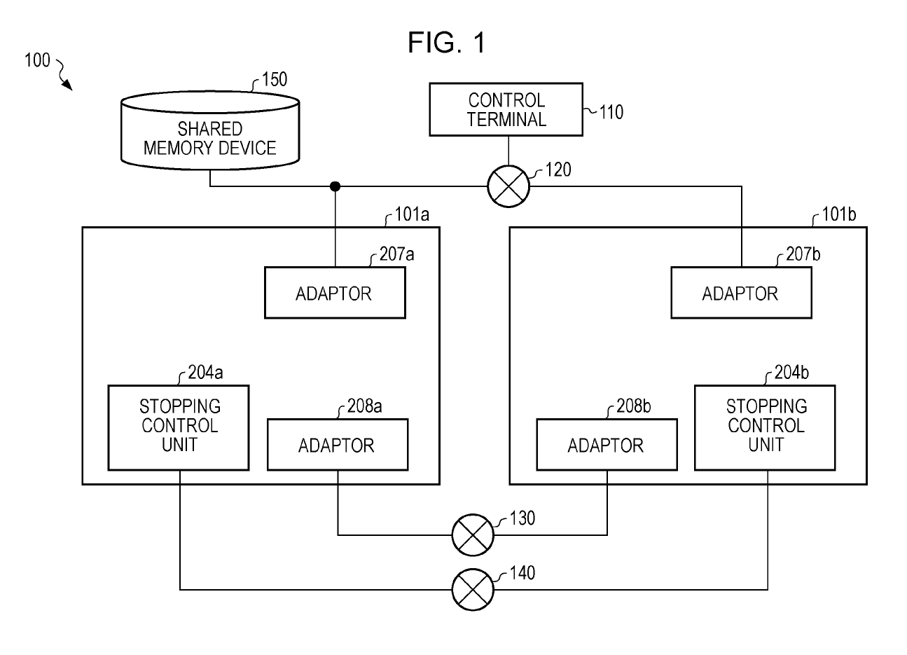

An aspect of the embodiment will be discussed hereinbelow. FIG. 1 illustrates a configuration of a control system 100.

The control system 100 of the present embodiment includes a node 101a and a node 101b. One of the nodes of the node 101a and the node 101b is an operational system, and the other is a standby system. The nodes 101a and 101b are both, for example, information processing machines such as servers for executing applications. FIG. 1 illustrates the two nodes 101a and 101b. However, the control system 100 may include three or more nodes, or may include a plurality of standby systems. The control system 100 according to the present embodiment includes two nodes with the node 101a being the operational system and the node 101b being the standby system.

The node 101a includes an adaptor 207a and the node 101b includes an adaptor 207b. The adaptors 207a and 207b are interconnected through a network 120. The node 101a includes an adaptor 208a and the node 101b includes an adaptor 208b. The adaptors 208a and 208b are interconnected through a network 130.

The node 101a includes a stopping control unit 204a and the node 101b includes a stopping control unit 204b. The stopping control units 204a and 204b are devices that are able to forcibly stop the respective nodes 101a and 101b, and may use, for example, a control device called a management board. The stopping control units 204a and 204b are connected through a network 140.

The control system 100 may include a shared memory device 150 that is connected to the nodes 101a and 101b through the network 120. For example, when an application executed by the node 101a and 101b performs database control, the database subject to the control may be stored in the shared memory device 150. The shared memory device 150 may be, for example, a storage device that includes a plurality of hard disk drives (HDD).

The control system 100 may also include a control terminal 110 that is able to be connected to the nodes 101a and 101b through the network 120 as illustrated in FIG. 1. When the control system 100 includes the control terminal 110, a system administrator, for example, uses the control terminal 110 to request the nodes 101a and 101b to start or stop executing an application.

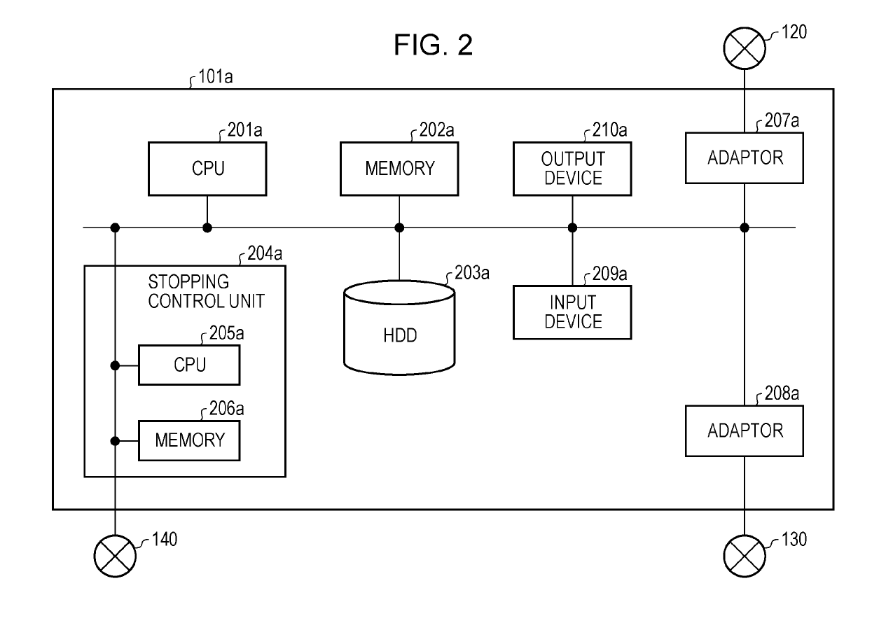

FIG. 2 illustrates an example of the node 101a. The node 101a includes a central processing unit (CPU) 201a, a memory 202a, and an HDD 203a, the stopping control unit 204a, and the adaptors 207a and 208a all of which are interconnected through a bus to enable communication. The CPU 201a controls the node 101a. The memory 202a and the HDD 203a are able to store, for example, information for controlling the node 101a, programs executed by the CPU 201a, and information related to the control system 100. The HDD 203a may be a type of storage device that differs from an HDD such as a semiconductor storage device. The stopping control unit 204a includes a memory 206a and a CPU 205a for implementing operations of the stopping control unit 204a. The outline of the operations of the stopping control unit 204a is described above. The adaptors 207a and 208a are connecting parts for connecting the nodes 101a and 101b through the networks 120 and 130. If the control system 100 includes the control terminal 110, the adaptors 207a and 208a connect the nodes 101a and 101b through the networks 120 and 130 to the control terminal 110. Network interface cards (NIC) may be used, for example, in the adaptors 207a and 208a. As illustrated in FIG. 2, the node 101a may also include an input device 209a for executing commands for the node 101a, and an output device 210a that outputs operating states of the node 101a and the control system 100. The input device 209a may be a keyboard and/or a mouse and the like. The output device 210a may be a display and/or a printer and the like.

The fundamental hardware configuration of the node 101b is the same as that of the node 101a and an explanation thereof will be omitted. The networks 120, 130, and 140 may be implemented by physically using one communication line for example, or each network may be implemented by physically separate communication lines.

A communication line for connecting the control terminal 110 and the nodes 101a and 101b may be newly provided.

(Software Configuration)

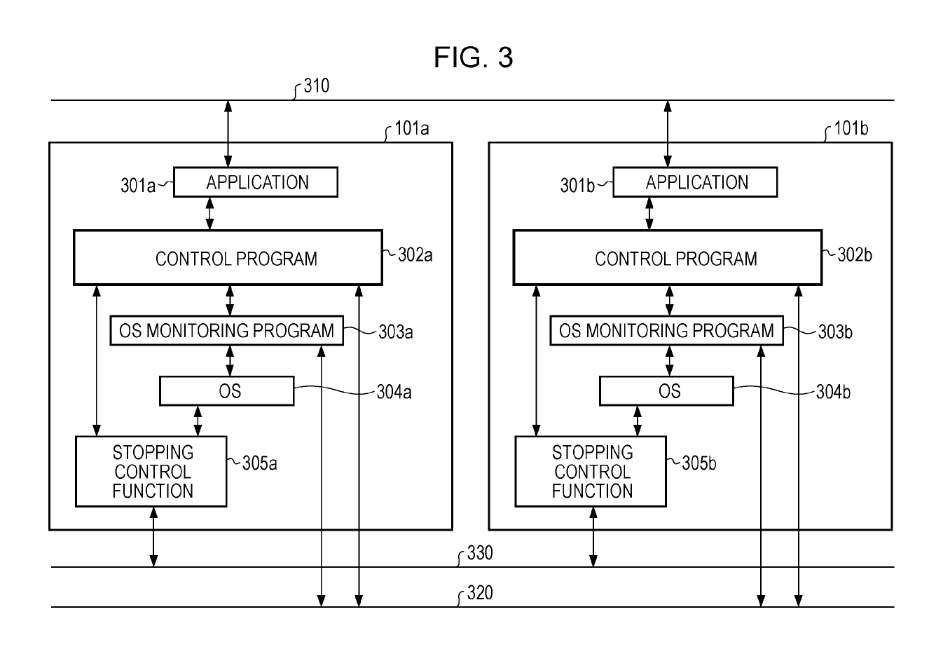

FIG. 3 illustrates a software configuration of the control system 100.

The software executed in the node 101a includes, for example, an application 301a, a control program 302a, an OS monitoring program 303a, an OS 304a, and a stopping control function (stopping control program) 305a as illustrated in FIG. 3.

The application 301a is an application executed in the node 101a. The control program 302a processes the activation and termination of, for example, the application 301a, and monitors the application 301a. The OS 304a controls the entire node 101a. The OS monitoring program 303a monitors the execution state of the OS 304a in the host node and the execution state of an OS 304b in another node. The stopping control function 305a is a unit for forcibly stopping the node 101a. The application 301a, the control program 302a, the OS monitoring program 303a, and the OS 304a are, for example, programs that are loaded into the memory 202a and executed by the CPU 201a. The stopping control function 305a may be a program executed, for example, by the stopping control unit 204a using the CPU 205a and the memory 206a in the stopping control unit 204a. The software configuration of the node 101b is the same as that of the node 101a. The components of the node 101b corresponding to the components 301a to 305a of the node 101a are indicated as 301b to 305b in FIG. 3.

An application communication path 310 is a network that connects the applications 301a and 301b. The application communication path 310 is implemented by using, for example, the network 120 illustrated in FIG. 1. A heartbeat communication path 320 is a communication path for sending and receiving commands and information (e.g., information indicating application operating states and the like) relating to the operating states of the nodes 101a and 101b. The heartbeat communication path 320 is implemented by using, for example, the network 130 illustrated in FIG. 1. A stopping control communication path 330 is a communication path for connecting the stopping control units 240a and 204b. The stopping control communication path 330 uses, for example, the network 140 illustrated in FIG. 1. Aspects of the connections of the nodes 101a and 101b illustrated in FIGS. 1 and 2 represent an example of an aspect of the control system 100. The aspects of the control system 100 for implementing the embodiment are not limited to the aspects illustrated in FIGS. 1 and 2. For example, it is possible to reduce risks due to network failures by using the network 130 illustrated in FIG. 1 as the heartbeat communication path 320, and by using the network 140 illustrated in FIG. 1 as the stopping control communication path 330. Similarly, a communication path may be prepared separate from the network 120 between the control terminal 110 and the shared memory device 150 to allow for a preferable independent connection between the nodes 101a and 101b.

(Explanation of Application Activation Operation)

The following is an explanation of a procedure for activating the application 301b in the standby system with reference to FIGS. 3 and 4. In this procedure, even if the control program 302a in the operational system is stopped and the operating state of the application 301a is unclear, the application 301b is activated without allowing the occurrence of a state in which the application 301a and the application 301b are operating at the same time. FIG. 4 is a flow chart illustrating a procedure of the control system 100 when the application 301b is activated.

First, an operation administrator sends a request to the control program 302b to activate the application 301b (S401). The request for the activation (referred to below as “activation request”) is executed, for example, by the system operation administrator using the control terminal 110 and the input device 209b of the node 101b. In addition to the request for the activation of the application 301b, information about whether a forced activation is requested may be included in the activation request. For example, when work in the standby system is restarted while the application 301a is not functioning, the operation administrator requests that the application 301b is quickly activated without confirming the operating state of the application 301a. When the application 301b is quickly activated without confirming the operating state of the application 301a, the operation administrator requests the forced activation along with the activation request. The activation request is a command inputted by using, for example, the control terminal 110 and the input device 209a of the node 101b. The activation request may be issued using a graphical user interface (GUI) installed in the control terminal 110 and the node 101b. The forced activation request may also be performed after the activation request.

The control program 302b that receives the activation request determines whether the application 301a is operating (S402). The determination of whether the application 301a is operating is made possible by, for example, the control program 302b storing, in the memory 202b or the HDD 203b, information that indicates the operating state of the application 301a received from the control program 302a through the abovementioned heartbeat communication path 320, and thus the determination may be made on the basis of the stored information. The control program 302b may periodically perform communication using a heartbeat.

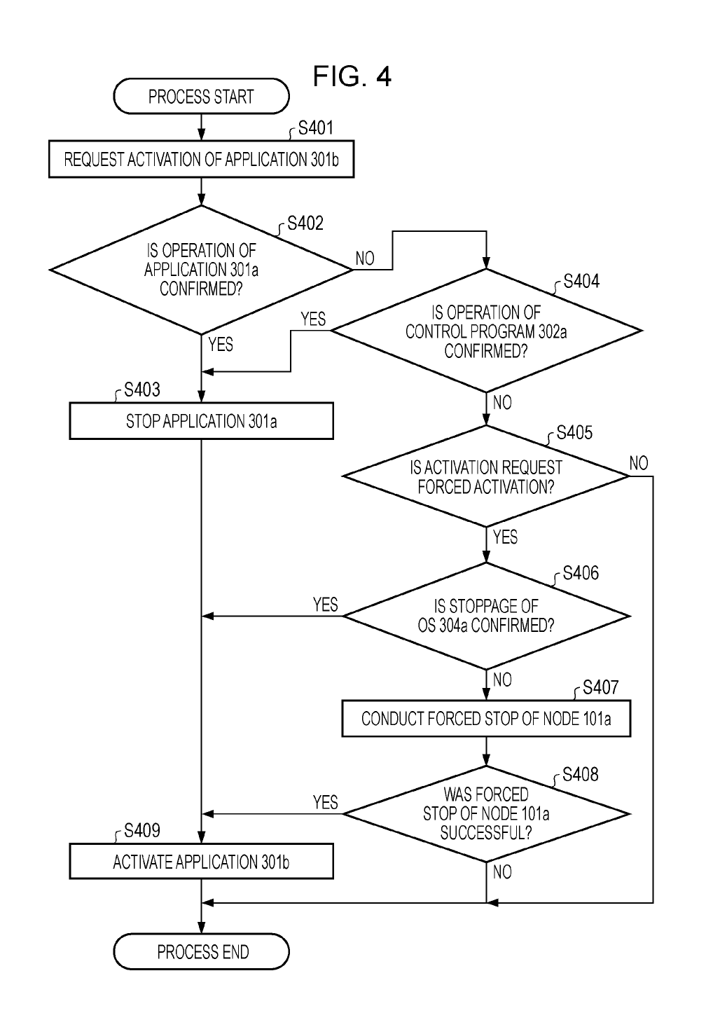

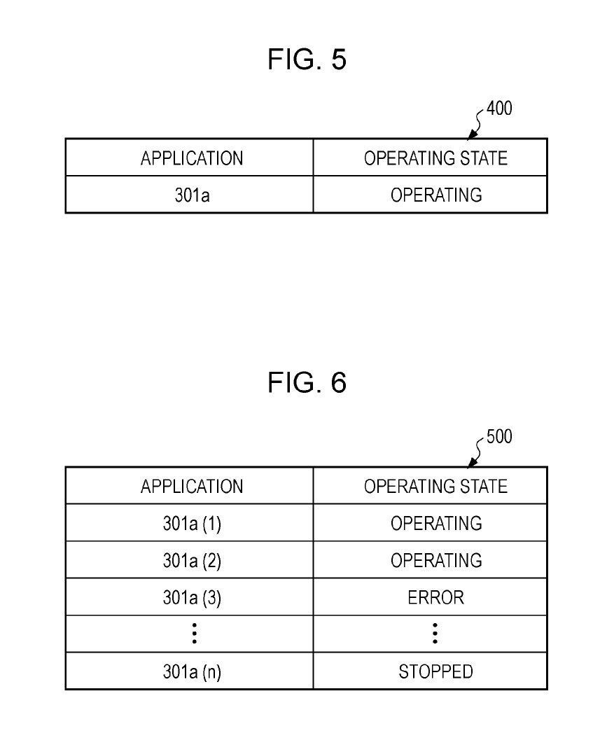

The information that indicates the operating state of the application 301a is application information 400 illustrated, for example, in FIG. 5. The application information 400 illustrated in FIG. 5 represents an example of a set of application 301a identification information (“301a” in this case) and the application 301a operating state. Aspects of the application information 400 are not limited to the aspects illustrated in FIG. 5 for implementing the present embodiment. For example, when the node 101a is executing a plurality of applications 301a(1) to 301a(n), information of operating states for each application may be stored as illustrated by application information 500 in FIG. 6. As an example of another method, when the activation request is received, the control program 302b may query the control program 302a for the operating state of the application 301a through the heartbeat communication path 320 and then confirm the operating state on the basis of the contents of the reply with respect to the query. Although “stopped” is described as an application operating state in FIGS. 5 and 6, “stopped” may be recorded as the operating state not only when information is obtained that indicates that the application is actually stopped, but also “stopped” may be recorded as the operating state when heartbeats are not able to be received and the confirmation as to whether the application is operating or not is not possible.

Returning to the explanation in FIG. 4, the control program 302b sends a request to the control program 302a to stop the application 301a when it is determined that the application 301a is operating (S403) (referred to as “stoppage request” below). The control program 302a that receives the stoppage request from the control program 302b causes the application 301a to be stopped in response to the stoppage request. After the stoppage of the application 301a is completed, the control program 302a sends information indicating that the application 301a is stopped to the control program 302b. When the control program 302b receives the information indicating that the application 301a is stopped, the control program 302b activates the application 301b (S409). In response to the execution of step S409, the control program 302b may update the application information 400 or 500 stored in the memory 202b on the basis of the information indicating the stoppage of the application 301a.

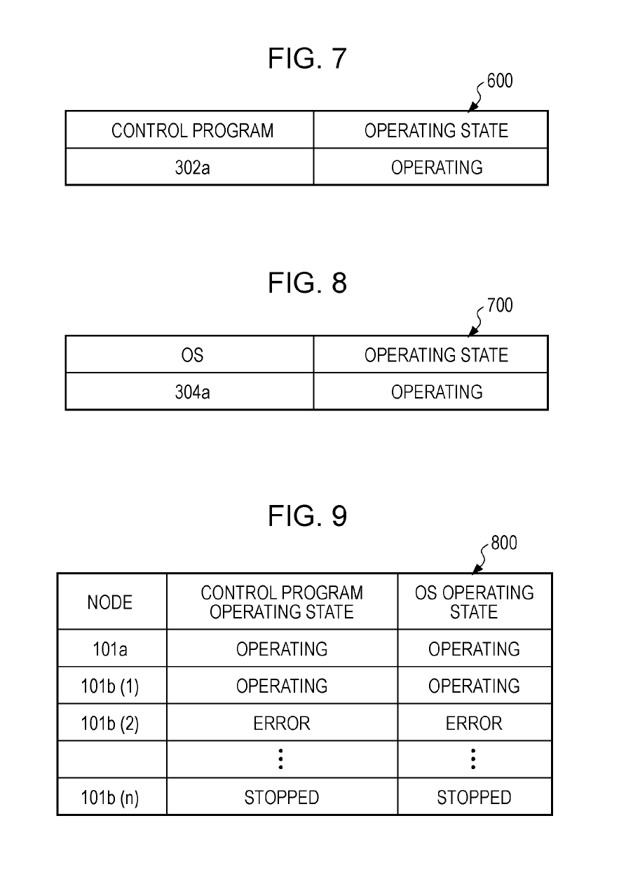

On the other hand, if the control program 302b is not able to confirm whether the application 301a is operating (if the application operating state is stored as “stopped” or stored as “error”), the control program 302b determines whether the control program 302a is operating (S404). The determination of whether the control program 302a is operating may be performed by, for example, the control program 302b storing, in the memory 202b or the HDD 203b, information that indicates the operating state of the control program 302a, and thus the determination may be made on the basis of the stored information. Control program information 600 illustrated in FIG. 7 is an example of information in which the control program 302a and the operating state of the control program 302a are stored in association with each other. Although the control program operating state is described as “stopped” in FIG. 7, “stopped” may be used to describe the operating state not only when information that indicates that the control program is actually stopped is obtained by heartbeat, but also “stopped” may be recorded as the operating state when heartbeats are not able to be received and the confirmation as to whether the control program is operating or not is not possible. Aspects of the control program information 600 are not limited to the aspects illustrated in FIG. 7 for implementing the present embodiment. Moreover, when the activation request is received, the control program 302b may query the control program 302a for the latest operating state of the control program 302a through the heartbeat communication path 320 and then confirm the operating state on the basis of the contents of the reply with respect to the query.

When it is determined that the control program 302a is operating, the control program 302b executes the processing in step S403.

On the other hand, if the determination as to whether the control program 302a is operating is not made (if the control program 302a operating state is detected as “stopped” or detected as “error”), the control program 302b confirms whether the activation request is a forced activation (S405). If it is determined that the activation request is not a forced activation, the control program 302b finishes the processing based on the activation request. When the processing based on the activation request is finished, the processing may restart from step S402 after confirming, for example, the activation of the control program 302a.

On the other hand, if it is determined that the activation request is a forced activation, the control program 302b determines whether the OS 304a has stopped (S406). The control program 302b sends a request to determine whether the OS 403a is stopped to the OS monitoring program 303b. The OS monitoring program 303b that receives the request determines whether the OS 403a is stopped. The determination of whether the OS 304a is stopped may be performed by, for example, storing OS information 700 in the memory 202b or the HDD 203b, and the control program 302b referring to the stored information to determine the operating state of the OS 304a. The OS information 700 illustrated in FIG. 8 as an example is information in which the OS 340a and an operating state of the OS 304a are stored in association with each other. The OS information illustrated in FIG. 8 is one aspect of information to confirm the operating state of the OS 304a and aspects of the OS information 700 are not limited to the aspect illustrated in FIG. 8 for implementing the embodiment. As an example of another method, when the activation request is received, the OS monitoring program 303b may query the OS monitoring program 303a for the operating state of the OS 304a through the heartbeat communication path 320. The operating state of the OS 304a may be confirmed by the OS monitoring program 303b notifying the control program 302b about the contents (stopped, operating, error) of the reply in response to the query. When it is determined that the OS 304a is stopped, the control program 302b executes the processing in step S409. Specifically, the control program 302b is able to assume that the application 301a is stopped since the node 101a is stopped if the OS 304a is stopped.

On the other hand, the control program 302b forcibly stops the node 101a if it is not determined that the OS 304a is stopped (when operating or an error occurs) (S407).

An example of a procedure to forcibly stop the node 101a in S407 will be explained in detail. The control program 302b sends a request to the stopping control unit 204b to forcibly stop the node 101a. The stopping control unit 204b that receives the request to forcibly stop the node 101a sends a request to the stopping control unit 204a through the stopping control communication path 330 to stop the node 101a. The stopping control unit 204a that receives the request to stop the node 101a then stops the node 101a. The method of stopping the node 101a may be a method in which the stopping control unit 204a stops the OS 304a by causing, for example, a kernel panic in the OS 304a, then the node 101a stops. Moreover, the stopping control unit 204a may, for example, have a function to control the power of the node 101a and then stop the power of the node 101a in response to the forced stoppage request to stop the node 101a.

When the stopping control unit 204a detects the stoppage of the OS 304a by stopping the node 101a, the stopping control unit 204a sends information indicating that the OS 304a is stopped to the stopping control unit 204b through the stopping control communication path 330. The stopping control unit 204b that receives the information indicating that the OS 304a is stopped sends the information indicating that the OS 304a is stopped to the control program 302b. If the information indicating that the OS 304a is stopped is sent to the OS monitoring program 303b, the OS monitoring program 303b may update the OS information 700 on the basis of the information indicating that the OS 304a is stopped. Moreover, if the stoppage of the OS 304a is not able to be detected, the stopping control unit 204a may send information indicating that the OS 304a was not able to be stopped to the stopping control unit 204b through the stopping control communication path 330.

The control program 302b determines whether the node 101a is stopped (S408). The processing advances to step S409 when the control program 302b determines that the node 101a is stopped. The determination that the node 101a is stopped is performed, for example, when the control program 302b has received the information from the stopping control unit 204b that the OS 304a is stopped.

On the other hand, when the control program 302b does not detect that the node 101a has stopped, the processing based on the activation request is finished. The fact that the stoppage of the node 101a is not detected indicates, for example, that the control program 302b received information indicating that the OS 304a was not able to be stopped from the stopping control unit 204b. Alternatively, the above fact may indicate that the control program 302b did not receive the information indicating that the OS 304a is stopped from the stopping control unit 204b after a certain amount of time had elapsed since the node 101a stoppage request had been sent in step S408. If the control program 302b does not detect that the node 101 is stopped, the control program 302b may, for example, re-execute the processing based on the activation request after a certain amount of time has elapsed. Further, when the stoppage of the node 101a is not detected, the control program 302b may perform the processing from steps S406 to S408 a certain amount of times, and may finish the processing based on the activation request if the node 101a is not able to be stopped even then.

In step S409, the control program 302b activates the application 301b. Since the application 301a is stopped when executing step S409, a state in which the application 301a and the application 301b are activated at the same time does not occur. The control program 302b confirms that the application 301b is activated and then finishes the processing based on the activation request. Upon finishing, the control program 302b may send information indicating that the application 301b is activated to a node other than the node 101a through the heartbeat communication path 320.

According to the above procedures, when for example an error occurs in the application 301a or the node 101a in the operational system, the application 301b in the standby system may be activated. According to the present embodiment, even if the control program 302a is in a stopped state or an error state, the application 301b may be activated without allowing a state to occur in which the application 301a and the application 301b are operating at the same time. Therefore, data corruption caused by, for example, the application 301a and the application 301b operating at the same time and accessing data stored in the shared memory device 150 at the same time, may be suppressed. According to the present embodiment, the node 101a is not forcibly stopped if a determination is made that the OS 304a is stopped. This is because, if the OS 304a is stopped, the application 301a operating on the OS 304a is also not operating, and thus the application 301a and the application 301b are not operating at the same time even if the application 301b is activated. According to the processing of the present embodiment, the opportunity to forcibly stop a node is reduced, and thus the time for recovery and the workload for system recovery due to a forced stop may be reduced.

In the present embodiment, the control system 100 has been described as having the two nodes embodied by the operational system node 101 and the standby system node 101b. However, the present embodiment may be achieved by a control system including three or more nodes. For example, in a control system having the node 101a and n number of nodes 101b(1) to 101b(n), the sending and receiving of information indicating the operating states in the operating steps in FIG. 4 may be executed between the node 101a and each of the nodes 101b(1) to 101b(n). If one control program and one OS are included in each node, the node 101a and the nodes 101b(1) to 101b(n) may each store the control program information 600 and the OS information 700 in the memory 202b or the HDD 203b. Moreover, information that indicates the operating state such as, for example, node information 800 as illustrated in FIG. 9 may be stored in the memory 202b or the HDD 203b.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable, non-transitory medium storing therein an application control program that causes an information processing machine to execute a procedure, the procedure comprising:
receiving an activation request that requests an activation of a first application of the information processing machine;
monitoring another information processing machine that executes a second application corresponding to the first application; and
activating the first application in response to the activation request when a stoppage of an operating system of the another information processing machine is detected.

2. The computer-readable, non-transitory medium according to claim 1, the operation further comprising:
activating the first application after stopping the operation system with a stopping unit for stopping the operating system when the stoppage of the operating system is not able to be detected.

3. The control program according to claim 1, wherein the activation request includes information that indicates that the activation of the first application is a forced activation.

4. A control method executed by an information processing machine, the method comprising:
receiving an activation request that requests an activation of a first application of the information processing machine;
monitoring another information processing machine that executes a second application corresponding to the first application; and
activating the first application in response to the activation request when a stoppage of an operating system of another information processing machine is detected.

5. A control system comprising:
a control device that sends an activation request;
a first information processing machine that stores a first application, receives the activation request, and monitors other information processing machine;
a second information processing machine that is monitored by the first information processing machine and stores a second application, the second application corresponding to the first application; wherein
the first information processing machine sends a stoppage request of an operating system to the second information processing machine when the stoppage of the operating system is not monitored and the activation request is received,
the second information processing machine stops the operating system in response to the stoppage request, and
the first information processing machine activates the first application when the stoppage of the operating system is detected.
